(19) United States
(12) Patent Application Publication
(10) Pub. No.: US 2004/0254702 A1
(43) Pub. Date: Dec. 16, 2004

(54) Method and apparatus for sensing a turn on a vehicle

(76) Inventor: Donald Lee Mueller, Waynesville, OH (US)

Correspondence Address: DELPHI TECHNOLOGIES, INC., M/C 480-410-202, PO BOX 5052, TROY, MI, 48007, US

(21) Appl. No.: 10/462,370

(22) Filed: Jun. 16, 2003

(51) Int. Cl. B60G 17/00

(52) U.S. Cl. 701/38; 701/1; 280/5.507

(57) ABSTRACT

A method and apparatus to detect a turning maneuver on a vehicle are shown. The invention measures a change in height of the vehicle chassis relative to a fixed point on the vehicle, e.g. a wheel axle. This information is combined with other vehicle inputs to determine when the vehicle is engaged in a turn maneuver, based upon preset thresholds. The method is also able to determine a magnitude of a turn maneuver, based upon preset criteria. The information regarding detection and magnitude of a turn maneuver can be used by other vehicle systems to enhance control and stability, improve braking, and provide other features and functions.

### TECHNICAL FIELD

This invention pertains generally to a vehicle, and more specifically to sensing a turning maneuver on a vehicle.

### BACKGROUND OF THE INVENTION

Technology that was initially developed for implementation on four wheel vehicles is now being implemented on two wheel vehicles, including for example, antilock braking systems, traction control systems and semi-active suspension systems. These systems can enhance the controllability of the vehicle similar to the enhancements to a four-wheel vehicle. However the application of these systems onto two-wheel vehicles must be done with consideration for their unique operating characteristics. One area wherein two-wheeled vehicles require special attention is their lateral stability. Two-wheel vehicles have unique stability concerns as a result of the fact that they lean, or roll as part of a turn maneuver. Lateral stability is important in that a failure to keep a wheel in frictional contact with a road surface can have catastrophic consequences for an operator.

There is a need to be able to effectively determine when a two-wheeled vehicle is in a turn maneuver in order to be able to manage an antilock braking system or a traction control system, or operate a semi-active suspension system. Several methods have been proposed to determine when a two-wheeled vehicle is in a turn maneuver and to determine the magnitude of a turn. This has included implementing sensors that monitor various characteristics of vehicle operation. The sensing devices have included accelerometer sensors that are positioned to measure force or acceleration of the vehicle in a lateral axis of the vehicle, i.e. determining whether the vehicle is leaning. These sensing devices are limited to low speed maneuvers (e.g. <25 mph/40 km/h) because as vehicle speed increases the lateral forces are countered by the centrifugal forces of the vehicle in the turn. A resultant force vector on the vehicle is actually parallel to a vertical axis of the two-wheeled vehicle, thus limiting the usefulness of any output from the accelerometer.

Another method includes a sensor that measures the degree that the handlebars are turned. This method lacks robustness in that a two-wheeled vehicle can execute a turn maneuver with little or no turning of the handlebars at higher speeds. In fact, counter-steering, or turning the handlebars in the opposite direction of the desired turn is often utilized to initiate a turn. In general, turn maneuvers on two-wheeled vehicles are dependent on a complex interaction of several factors including vehicle lean, shape of the tires, gyroscopic effects of the front wheel, in addition to the amount the handlebars are turned.

### SUMMARY OF THE INVENTION

The present invention is an improvement over conventional turning maneuver detection devices for two-wheeled vehicles in that it provides a method to measure the change in height of the vehicle chassis relative to a fixed point on the vehicle, e.g. a wheel axle. This information is combined with other vehicle inputs to determine when the vehicle is engaged in a turn maneuver, based upon preset thresholds. The method is also able to determine a magnitude of a turn maneuver, based upon preset criteria. The information regarding detection and magnitude of a turn maneuver can be used by other vehicle systems to enhance control and stability, improve braking, or provide other features.

A measured change in vehicle height results from an increase in suspension loading. If the vehicle speed is above zero, the assumption is made that a change in loading is not due to an increase in payload (i.e. addition of a rider or luggage). If proper filtering of road bumps, swells, and lift/dive effects of acceleration and deceleration are employed, then the assumption is made that a change (increase) in loading, and subsequent change (lowering) of vehicle height, is due to a turn maneuver. The increase in loading is due to a combination of gravitational forces and centrifugal forces wherein the resultant force on the suspension is greater than the gravitational force.

The present invention includes a sensing device that detects a change in height of the vehicle chassis, and translates this into an increase in a load placed upon a rear axle during vehicle operation. It detects the increase in load by measuring a change in height of the vehicle's chassis during operation. It then combines the measured information with other available vehicle information to determine the presence and magnitude of a turn maneuver.

These and other objects of the invention will become apparent to those skilled in the art upon reading and understanding the following detailed description of the embodiments.

### BRIEF DESCRIPTION OF THE DRAWINGS

The invention may take physical form in certain parts and arrangement of parts, the preferred embodiment of which will be described in detail and illustrated in the accompanying drawings which form a part hereof, and wherein:

FIG. 1 is a perspective view of the motorcycle, in accordance with the present invention;

FIG. 2 is another perspective view of the motorcycle, in accordance with the present invention;

FIG. 3 is a graphical depiction of a physical relationship, in accordance with the present invention;

FIG. 4 is another graphical depiction of a physical relationship, in accordance with the present invention;

FIG. 5 is a flow chart, in accordance with the present invention;

FIGS. 6A and 6B are response graphs, in accordance with the present invention; and

FIG. 7 is a system diagram for a motorcycle, with a controlled damper system.

### DETAILED DESCRIPTION OF THE PREFERRED EMBODIMENT

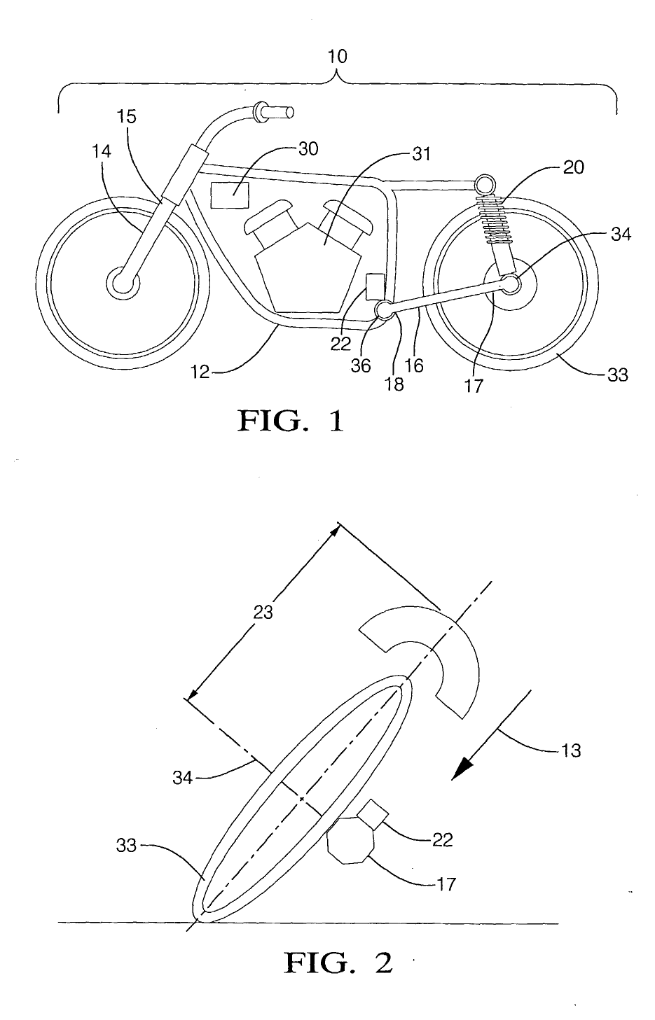

Referring now to the drawings, wherein the showings are for the purpose of illustrating the preferred embodiment of the invention only and not for the purpose of limiting the same, FIG. 1 shows a two-wheeled vehicle 10 which has been constructed in accordance with an embodiment of the present invention. The vehicle 10 comprises a chassis 12, a front fork 14, a front suspension system 15, at least one rear swing arm 16, and a rear suspension system 20. A first end 17 of the rear swing arm 16 is operably attached to a rear wheel 33 at a rear axle 34. A second end 18 of the rear swing arm 16 is pivotally attached to the chassis 12 at a pivot point 36. A first end of the rear suspension system 20 is attached to the chassis 12. A second end of the rear suspension system 20 is attached to the rear swing arm 16 near the first end 17. Chassis systems for two-wheeled vehicles are well known in the art.

The vehicle 10 also has an engine 31 and an electronic controller 30. The electronic controller 30 collects information from sensors on the engine 31 and chassis 12, and controls various output devices in accordance with predetermined algorithms and calibration tables (not shown). Typical chassis sensors include a vehicle speed sensor, yielding vehicle speed, a transmission sensor, and at least one wheel speed sensor (not shown). Typical engine sensors include an engine speed sensor, a throttle position sensor, and an engine manifold pressure sensor, yielding engine load, among others (not shown). Typical output devices from the controller 30 to the engine 31 can include injector drivers to control fuel injector pulsewidth, cruise control, or electronic throttle control systems (not shown). Typical output devices from the controller 30 to the chassis 12 include, for example, anti-lock braking systems, traction control systems, controlled suspension systems, and others (not shown). Electronic control systems including electronic controllers, sensors and output devices for engine and vehicle control are well known in the art.

The present invention also includes a height sensor 22 that is attached to the chassis 12. The height sensor 22 is configured to measure a height 23 of the chassis 12 relative to a fixed reference, which is the rear axle 34 of the vehicle 10 in this embodiment. The height sensor 22 is preferably a resistive-type sensor that is operably attached to the chassis 12 and the rear swing arm 16. The height sensor 22 provides an impedance output that varies with the position of the chassis 12 relative to the rear axle 34, as measured by a rotation of the rear swing arm 16 around the pivot point 36 on the chassis 12. The height sensor 22 may alternatively be a Hall effect sensor, wherein the sensor 22 is attached to the chassis 12 and a magnet (not shown) of the sensor 22 being attached to the rear swing arm 16 at or near the pivot point 36. The output of the height sensor 22 is input to the controller 30.

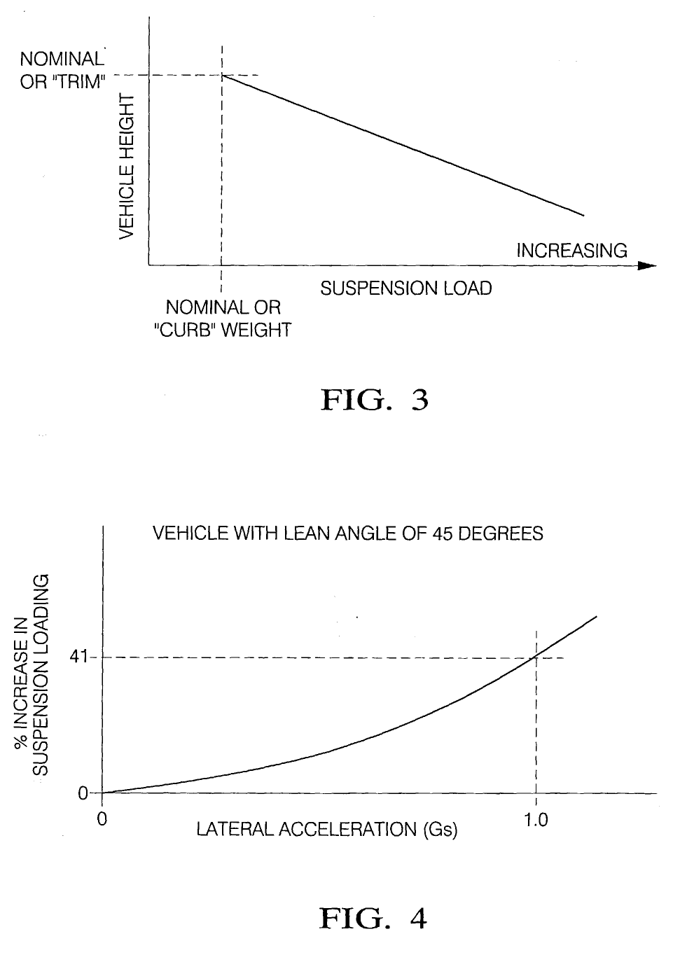

FIG. 2 shows a perspective view of the two-wheeled vehicle 10 engaged in a turn maneuver, wherein the height 23 between the axle 34 and the chassis 12 is measured, as described previously. A force vector representing a suspension load 13 is also shown that is parallel to a vertical axis of the two-wheeled vehicle 10. As shown in FIG. 3, there is a relationship between the vehicle height 23 and the suspension load 13. As shown in FIG. 4, there is also a relationship between a lateral acceleration of the vehicle and the suspension load 13. There are several factors that may have an effect upon the vehicle height, including operator demands, vehicle operating conditions, and road conditions, and will be discussed in more detail. The method discussed infra will act to identify and separate those factors from the lateral acceleration of the vehicle. Thus, a relationship between the vehicle height 23 and the lateral acceleration of the vehicle is determined and used by the present invention to determine when a turn maneuver is occurring.

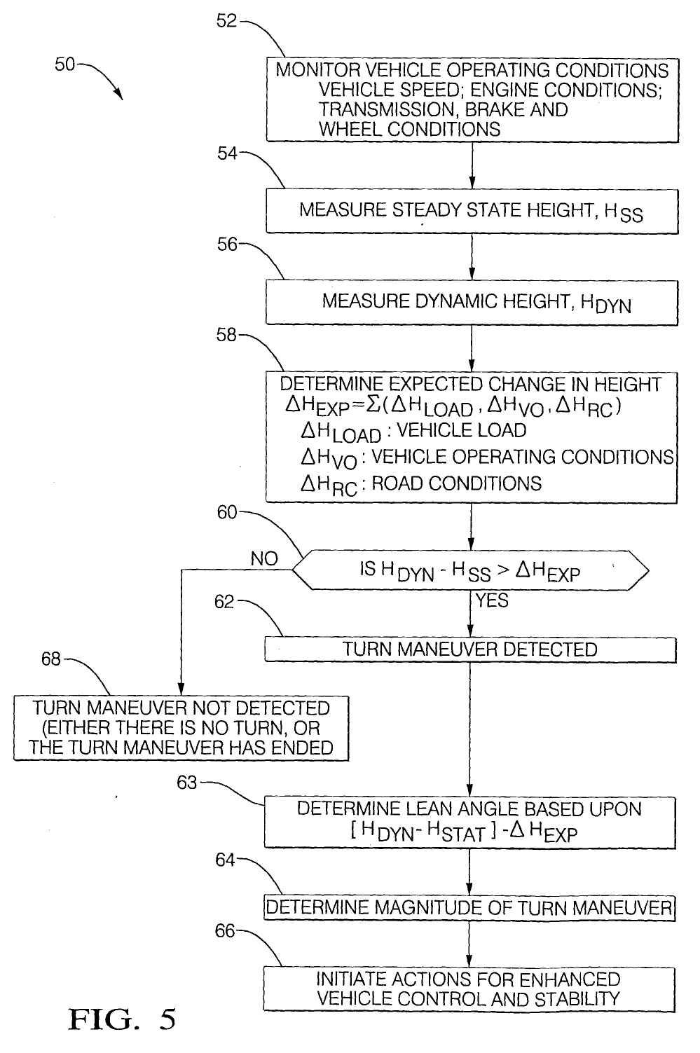

Referring now to FIG. 5, the invention includes a method for detecting a turn maneuver on a two-wheeled vehicle 10. This includes providing the two-wheeled vehicle 10 with the controller 30 as described in FIG. 1 and the height sensor 22. The vehicle operating conditions monitored by the controller 30 are preferably vehicle speed and engine operating conditions, including engine speed and engine load. The controller 30 may also monitor other operating conditions, including transmission, brake or wheel conditions (not shown) when that information is available electronically. The method operates initially by monitoring the vehicle height 23 and one or more of the vehicle operating conditions (see step 52).

The method continues by determining a height of the vehicle 10 under steady state operation (step 54). The steady state height H_{SS} is determined using the height sensor 22 when the vehicle 10 is operating in a steady state condition, during initial operation. The steady state condition is determined by evaluating vehicle speed, engine speed, engine load, or other conditions. Determination of when a vehicle is operating in a steady state mode is generally known to one skilled in the art. The controller 30 measures the steady state height H_{SS} when it has determined that the vehicle 10 has achieved steady state operation. Steady state operation is determined to be when at least one of the vehicle operating conditions is within a predetermined range for a predetermined amount of time. Appropriate range of values for steady state operation is determined by collecting data from representative vehicles that are tested under controlled conditions during the vehicle development process. The method anticipates that there will be no changes in vehicle height, H_{SS} due to a change in payload of the vehicle 10 once the vehicle is in motion. The value for H_{SS} is stored in the controller 30 for subsequent use during vehicle operation. The steady state height H_{SS} is also an indication of vehicle load, which can be used by other measurement systems.

The next step in the method is to measure the dynamic height H_{DYN} of the vehicle (step 56). The dynamic height H_{DYN} is measured continually while the vehicle is under operation, using the height sensor 22.

The following step is to determine an expected change in height of the vehicle, ΔH_{EXP} (step 58). The expected change in height ΔH_{EXP} is determined based upon vehicle operating conditions and operator demands, road conditions and vehicle load. This will be described in more detail in the following paragraphs.

A change in vehicle height that occurs when the vehicle is in motion may be due to a change in vehicle operating conditions and operator demands, e.g. acceleration, deceleration or braking that lead to lift or dive of the vehicle. This change in height is referred to as ΔH_{VO}. The change in height ΔH_{VO} is determined using information from the height sensor 22 and one or more of the vehicle sensors that are used to sense vehicle operating conditions. The vehicle operating conditions include, for example, vehicle speed, throttle position, engine speed, engine load, the steady state height, H_{SS}, and transmission or braking conditions (not shown). The information from the aforementioned vehicle sensors is used by the controller 30 to determine the instantaneous operator demands for acceleration or deceleration.

The change ΔH_{VO} for a series of combinations of vehicle operating conditions is also dependent upon the configuration of the vehicle suspension, wheels and tires. The change ΔH_{VO} is determined by testing representative vehicles during the vehicle development process, wherein ΔH_{VO} is measured under controlled conditions for a range of vehicle operating conditions and loads. This information is compiled and stored in the controller 30 as a table or equation for subsequent use during vehicle operation. In operation, the controller 30 monitors vehicle operating conditions and vehicle load. The controller 30 determines any change in height due to vehicle operating conditions by selecting a value for ΔH_{VO} based upon the sensed vehicle operating conditions.

Another source of change in the suspension loading that occurs when the vehicle is in motion includes a change in road conditions, e.g. swells, bumps and potholes. A change in vehicle height due to road conditions, ΔH_{RC}, is determined using information from the height sensor 22 and sensors that monitor vehicle performance during vehicle operation. The magnitude of the change in vehicle height ΔH_{RC} is determined by evaluating a time-rate change of the vehicle height 23 compared to the vehicle speed. The magnitude of the change is considered in light of specific characteristics of the vehicle, including for example, wheel size, tire size and shape, recommended tire inflation and stiffness, and suspension stiffness. For example, when the change in height is greater than 2 centimeters per millisecond, the method determines that the vehicle is on a rough road, or has hit a pothole. When the controller 30 captures the time-rate change of the vehicle height 23 and the vehicle speed, it determines the expected change in height due to road conditions, ΔH_{RC}. Differently configured vehicles will have different responses to changing road conditions. Therefore threshold values and expected characteristic performance have to be determined during the vehicle development phase, with data collected while testing on representative vehicles. In any event, the operation of measuring and evaluating ΔH_{RC} occurs in the controller 30, and a value for ΔH_{RC} is also stored therein for subsequent use.

The expected change in height ΔH_{EXP} is a summation of the expected changes in height due to vehicle load, ΔH_{LOAD}, vehicle operating conditions, ΔH_{VO}, and road conditions, ΔH_{RC}, as shown in step 58.

The method next calculates a difference between the dynamic height, H_{DYN} and the steady state height, H_{SS}, and compares the resultant value to the expected change in height, ΔH_{EXP} (step 60). When there is no turn maneuver, the calculated difference is approximately equal to the expected change in height ΔH_{EXP} under normal, steady state vehicle operation (step 68). When no turn is detected, the method continues to monitor the vehicle operating conditions, but will not act to adjust any other vehicle systems.

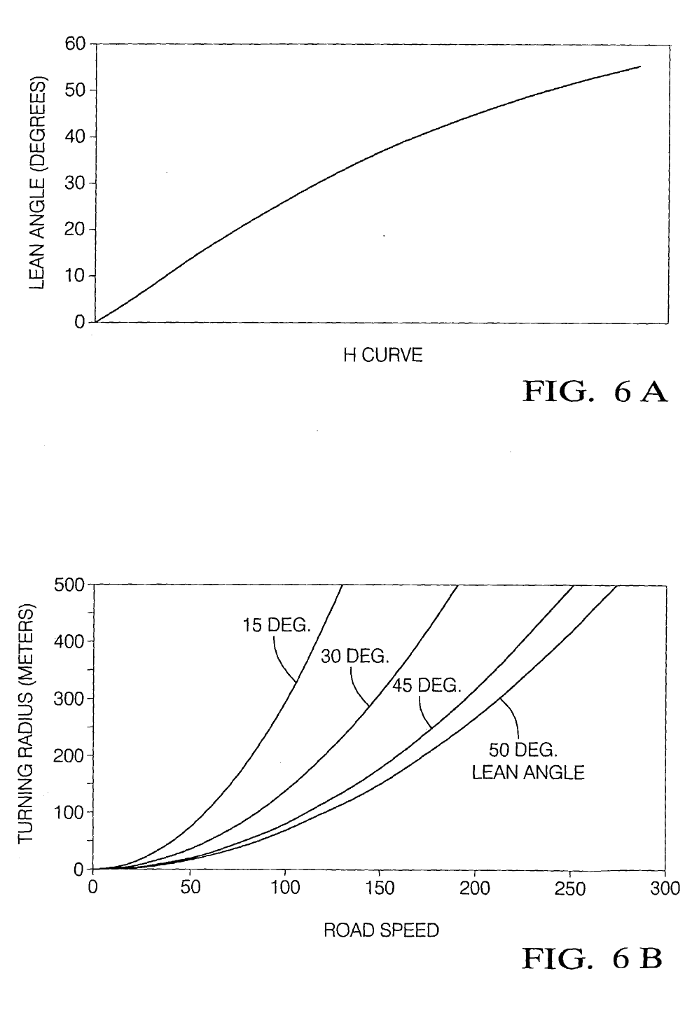

A turn maneuver is detected when the difference between the dynamic height, H_{DYN} and the steady state height, H_{SS}, is greater than the expected change in height, ΔH_{EXP} (step 62). A lean angle of the turn maneuver can then be determined based upon the difference between the dynamic height, H_{DYN} and the steady state height, H_{SS}, less the expected change in height, ΔH_{EXP} (step 63). The magnitude of the lean angle is determined by calculating a differential height H_{CURVE}=(H_{DYN}−H_{SS})−ΔH_{EXP}, which has a direct relationship to lateral acceleration of the vehicle. The resulting H_{CURVE} value is used to determine the lean angle (step 63), as follows. A relationship between the H_{CURVE} value and the lean angle (shown in FIG. 6A) is determined during the vehicle development process and stored in the controller 30 as a table or an equation. The lean angle is then used in conjunction with the vehicle speed to determine a magnitude of a turning radius, as shown in FIG. 6B and step 64. The controller 30 uses the lean angle and the magnitude of the turning radius when it initiates actions to enhance vehicle control and stability (step 66).

The values for ΔH_{EXP} are determined during vehicle development and calibration. The vehicle developer will measure expected values for change in height ΔH_{EXP} under predetermined combinations of vehicle loads, vehicle operating conditions, and road conditions. These values for ΔH_{EXP} are stored in the controller 30 as tables or equations. The turn maneuver information from step 64 is communicated to other vehicle systems. The vehicle can then complete any actions to enhance control and stability of the vehicle, or control braking, or turn off a turn signal control (step 66).

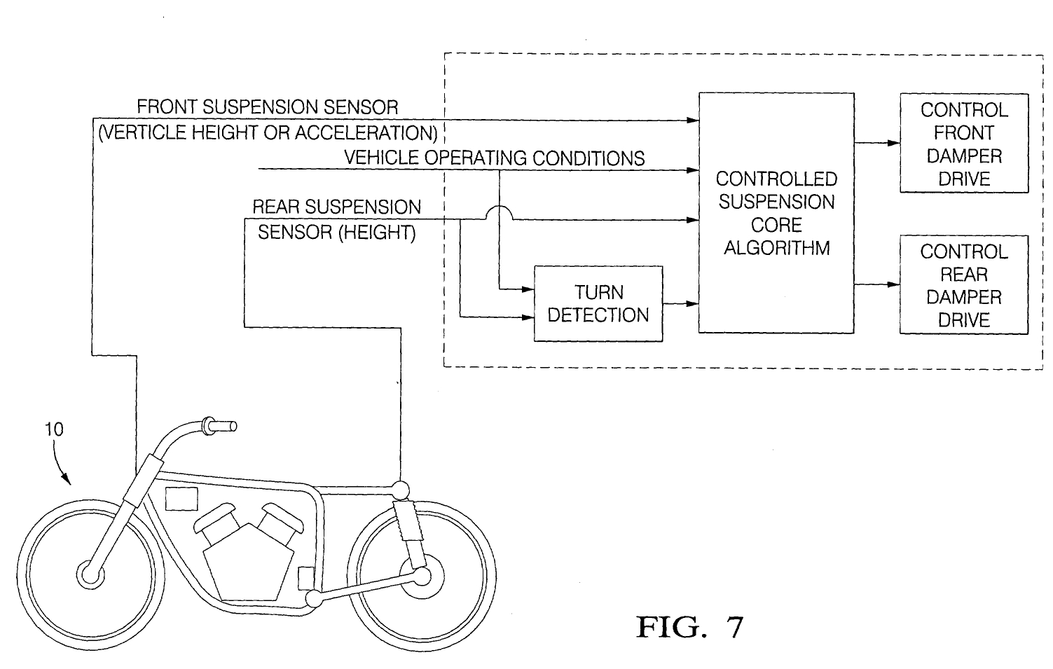

Potential intended uses include enhanced suspension control and stability with some form of controlled suspension (see FIG. 7), traction control, or improved braking using an anti-lock braking system. For example, adjustment of a controlled suspension system during a turn maneuver may not be critical at conditions of low vehicle speed and low engine load. In contrast, an anti-lock braking system or traction control system may need information to detect when a turn maneuver is occurring during a low vehicle speed, high engine load condition.

One such control system is shown in FIG. 7, which comprises an enhanced vehicle control and stability system. An example of a controllable suspension system includes at least one magnetorheological damper 80 that is controlled by an algorithm in the controller 30. Controlled suspension systems and magnetorheological damper systems are known to those skilled in the art.

One alternate embodiment comprises the two-wheeled vehicle system in FIG. 1, wherein the measured height input is used to determine road conditions at all times, and to control the various vehicle systems based upon the input to the controller. For example when a change in measured height exceeds a given level, the controller can determine that the vehicle is on a rough road. The controller 30 can begin operation in a ‘rough road’ mode, i.e. a specific control method intended for use when unusual or excessive variations in road conditions have been detected.

The invention has been described with specific reference to an application on a two-wheeled vehicle. Alternatively, this invention may be used to sense and control turning maneuvers on other vehicles. For example, the invention may be applicable to 3-wheeled vehicles, track-type vehicles such as snowmobiles, and agricultural/construction equipment.

The invention has been described with specific reference to the preferred embodiments and modifications thereto. Further modifications and alterations may occur to others upon reading and understanding the specification. It is intended to include all such modifications and alterations insofar as they come within the scope of the invention.

Having thus described the invention, it is claimed:

1. A method for detecting a turn maneuver on a two-wheeled vehicle, comprising:
monitoring at least one vehicle operating condition;
determining a steady state height of the vehicle, based upon the at least one vehicle operating condition;
measuring a dynamic height of the vehicle, based upon the at least one vehicle operating condition;
determining an expected change in height, based upon the at least one vehicle operating condition; and
comparing a difference between the dynamic height and the steady state height with the expected change in height.

2. The method in claim 1, including providing a height sensor that measures a height between a chassis member and an axle on the vehicle.

3. The method in claim 2, wherein the height sensor comprises a resistive sensor.

4. The method in claim 2, wherein the height sensor comprises a Hall effect sensor.

5. The method in claim 1, wherein determining a steady state height comprises measuring the height of the vehicle when the at least one vehicle operating condition is within a predetermined range.

6. The method in claim 1, wherein measuring a dynamic height comprises measuring the height of the vehicle when the at least one vehicle operating condition is within a predetermined range for a predetermined amount of time.

7. The method in claim 1, wherein monitoring at least one vehicle operating condition comprises monitoring vehicle speed.

8. The method in claim 7, wherein monitoring at least one vehicle operating condition further comprises monitoring at least one engine operating condition.

9. The method in claim 8, wherein monitoring at least one vehicle operating condition further comprises monitoring at least one transmission condition.

10. The method in claim 8, wherein monitoring at least one vehicle operating condition further comprises monitoring at least one braking condition.

11. The method in claim 1, wherein determining an expected change in height comprises selecting a value based upon the sensed vehicle operating conditions from a calibration table in an on-board controller.

12. The method in claim 1, wherein determining an expected change in height comprises:
determining a change in height based upon vehicle load;
determining a change in height based upon said vehicle operating conditions;
determining a change in height based upon road conditions; and
selecting a value based upon the vehicle operating conditions from a calibration table in an on-board controller.

13. The method in claim 1, wherein determining an expected change in height comprises calculating a value based upon the sensed vehicle operating conditions from an equation in an on-board controller.

14. The method in claim 2, wherein the predetermined range is defined to be a steady state, low vehicle speed operating condition.

15. A method for determining a magnitude of a turn maneuver on a vehicle, comprising:
monitoring at least one vehicle operating condition;
determining a steady state height of the vehicle;
measuring a dynamic height of the vehicle;
determining an actual change in height, based upon a difference between the dynamic height and the steady state height;
determining an expected change in height, based upon the at least one vehicle operating condition; and
determining a difference between the actual change in height and the expected change in height.

16. The method in claim 15, wherein monitoring at least one vehicle operating condition comprises monitoring engine load and engine speed.

17. The method in claim 15, wherein monitoring at least one vehicle operating condition comprises monitoring vehicle speed, engine load and engine speed.

18. A method for detecting a turn maneuver on a vehicle, comprising:
monitoring at least one vehicle operating condition;
measuring a dynamic load, based upon the at least one vehicle operating condition;
determining an expected load; and
comparing the dynamic load with the expected load.

19. The method in claim 18, including providing a load detection sensor for measuring the dynamic load.

20. A method for controlling a suspension system on a vehicle during a turn maneuver, comprising:
providing a controllable suspension system;
monitoring at least one vehicle operating condition;
determining a steady state height of the vehicle;
measuring a dynamic height of the vehicle;
determining an expected change in height, based upon the at least one vehicle operating condition;
comparing a difference between the dynamic height and the steady state height with the expected change in height; and
adjusting said controllable suspension system based upon said difference and said vehicle operating conditions.

21. The device in claim 20, wherein the controllable suspension system comprises a magnetorheological damper system.
